(19) United States
(12) Patent Application Publication
(10) Pub. No.: US 2023/0229477 A1
(43) Pub. Date: Jul. 20, 2023

(54) UPGRADE OF CELL SITES WITH REDUCED DOWNTIME IN TELCO NODE CLUSTER RUNNING CONTAINERIZED APPLICATIONS

(71) Applicant: VMware, Inc., Palo Alto, CA (US)

(72) Inventors: Xiaojun Lin, Beijing (CN); Liang Cui, Beijing (CN); Wenwu Peng, Beijing (CN); Aravind Srinivasan, Sunnyvale, CA (US); Hemanth Kumar Pannem, Danville, CA (US); Narendra Kumar Basur Shankarappa, Fremont, CA (US)

(21) Appl. No.: 17/693,274

(22) Filed: Mar. 11, 2022

(30) Foreign Application Priority Data
Jan. 18, 2022 (WO) PCT/CN2022/072488

(51) Int. Cl. G06F 9/455; G06F 9/50; H04W 48/18

(52) U.S. Cl. CPC G06F 9/45558; G06F 9/5077; H04W 48/18; G06F 2009/4557; G06F 2009/45595; G06F 2009/45562

(57) ABSTRACT

A computer-implemented method, medium, and system for upgrade of telco node cluster running cloud-native network functions are disclosed. In one computer-implemented method, a worker node group that includes a plurality of worker nodes is determined in a container orchestration platform. A first node to upgrade is determined within the worker node group. All pods in the first node are deactivated by a high availability as a service (HAaaS) module. Standby pods in a second node are activated by the HAaaS module and as active pods. All network traffic associated with all the pods in the first node is migrated to the active pods. The first node is deleted from the worker node group. Hardware resources associated with running the first node are released. A third node is generated as a new worker node in the worker node group and uses the released hardware resources.

### TECHNICAL FIELD

The present disclosure relates to computer-implemented methods, medium, and systems to upgrade nodes in a telco node cluster running cloud-native network functions.

### BACKGROUND

Telecommunication (hereafter “telco”) industry is accelerating as transition to 5G business, container orchestration platform, and cloud-native network functions (CNFs) solutions are getting more attention and deployment. A container orchestration platform enables the automation of much of the operational effort required to run containerized workloads and services. This includes a wide range of things needed to manage a container's lifecycle, including, but not limited to, provisioning, deployment, scaling (up and down), networking, and load balancing. A container orchestration platform can have multiple pods, with each pod representing a group of one or more application containers, as well as some shared resources for those containers. A container orchestration platform can host different container based platforms that support different functions. For example, a container based platform can be added to a container orchestration platform to support telco CNFs. When a new version of a container based platform supporting telco CNFs becomes available, nodes in a cluster of nodes of the container based platform need to be upgraded to include new telco CNF features and deliver better telco CNF performance supported by the new version of the container based platform. This upgrade process may negatively impact the downtime associated with the telco CNFs supported by the container based platform whose nodes are being upgraded.

### SUMMARY

The present disclosure involves computer-implemented method, medium, and system for upgrade of nodes in a telco node cluster running CNFs. One example computer-implemented method includes determining a worker node group that includes a plurality of worker nodes in a container orchestration platform, where each worker node in the worker node group performs 5G radio access network (RAN) cell site cloud-native network functions (CNFs), and where each worker node corresponds to a corresponding cell site tower in a 5G network. A first node to upgrade is determined within the worker node group, where the first node corresponds to a first cell site tower in the 5G network. All pods in the first node are deactivated by a high availability as a service (HAaaS) module. Standby pods in a second node are activated by the HAaaS module and as active pods, where the second node is associated with a second cell site tower. All network traffic associated with all the pods in the first node is migrated to the active pods in the second node. The first node is deleted from the worker node group. Hardware resources associated with running the first node are released. A third node corresponding to the first cell site tower is generated as a new worker node in the worker node group and uses the released hardware resources.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts an environment architecture of an example computer-implemented system that can execute implementations of the present disclosure.

FIG. 2 illustrates an example system for upgrading, using an in-place upgrade policy, nodes in a node group in a telco node cluster running RAN CNFs in a container orchestration platform and on cell sites, in accordance with an example implementation of this disclosure.

FIG. 3 illustrates an example system for upgrading, using a node group upgrade policy, nodes in a node group in a telco node cluster running 5G Core CNFs in a container orchestration platform, in accordance with another example implementation of this disclosure.

FIG. 4 illustrates an example system for upgrading, using a rolling upgrade policy, nodes in a node group in a telco node cluster running containerized applications associated with CNFs in a container orchestration platform, in accordance with a further example implementation of this disclosure.

FIG. 5 is a flowchart illustrating an example of a method for cell site upgrade in telco node cluster running containerized applications, in accordance with example implementations of this disclosure.

FIG. 6 is a schematic illustration of example computer systems that can be used to execute implementations of the present disclosure.

### DETAILED DESCRIPTION

Telco CNFs can be run on pods in a cluster of nodes in a container orchestration platform, and can be grouped into two groups: one is the 5G core CNFs and the other is radio access network (RAN) CNFs. 5G core CNFs can be run on a cluster of nodes inside a large datacenter with shared storage. 5G RAN CNFs can be run on a cluster of nodes with limited hardware resources. For cell site CNF, which is a type of RAN CNF, each CNF may require a specific server and special hardware, for example, field programmable gate arrays (FPGA), single root input/output virtualization (SR-IOV) network interface controller (NIC) devices, and precision time protocol (PTP) devices, to satisfy performance requirements.

Some existing strategies for upgrading nodes in a cluster of nodes require a new worker node with new version to be created first before a to-be-upgraded worker node in the cluster of nodes that has old version is deleted. This may lead to difficulties in meeting the downtime requirement of telco workloads. Additionally, since different types of CNFs may need different worker virtual machine (VM) customization options and different hardware resources, one type of CNFs will only be running on one node group, and some existing strategies for upgrading nodes cannot be used to support upgrading nodes with different types of CNFs. For RAN CNFs, there may not be extra resources for new worker node to be created first.

This disclosure describes technologies for upgrading nodes in telco node cluster running containerized applications. In some implementations, different types of upgrade strategies can be used for different worker node groups having different types of CNFs.

In one example, nodes in a node group in a cluster of nodes associated with cell sites run RAN CNFs with limited hardware resources, and are upgraded using an in-place upgrade strategy, where no extra hardware resources are available for a new worker node to be created before an old worker node is deleted. Therefore the in-place upgrade process includes deleting an old node with old version before creating a new node with new version to replace the deleted old node. Additional steps are included in the in-place upgrade strategy to mitigate service downtime due to the deletion of the old node before the creation of the new node.

In another example, nodes in a node group run 5G core CNFs inside a large data center with shared storage, and are upgraded using a node group upgrade strategy, where extra hardware resources are available for a new worker node group to be created before an old worker node group is deleted, thereby mitigating service downtime.

In some implementations, an upgrade manager is introduced to support different upgrade strategies for different node groups having different types of telco CNFs. The upgrade manager can include a notification sub-system to notify a high availability as a service (HAaaS) to activate standby CNFs and migrate network traffic to these standby CNFs. With this notification sub-system, the upgrade manager has the capability to notify different health monitors to mitigate service downtime, and it can reduce human intervention during an upgrade process, in order to achieve zero touch upgrade process. For example, in a rolling upgrade strategy, an upgrade manager can leverage cluster manager in a container orchestration system to create a new worker node before deleting an old worker node, while sending events about node changes to the HAaaS service using the notification sub-system in the upgrade manager in order to mitigate service downtime through traffic routing by the HAaaS service.

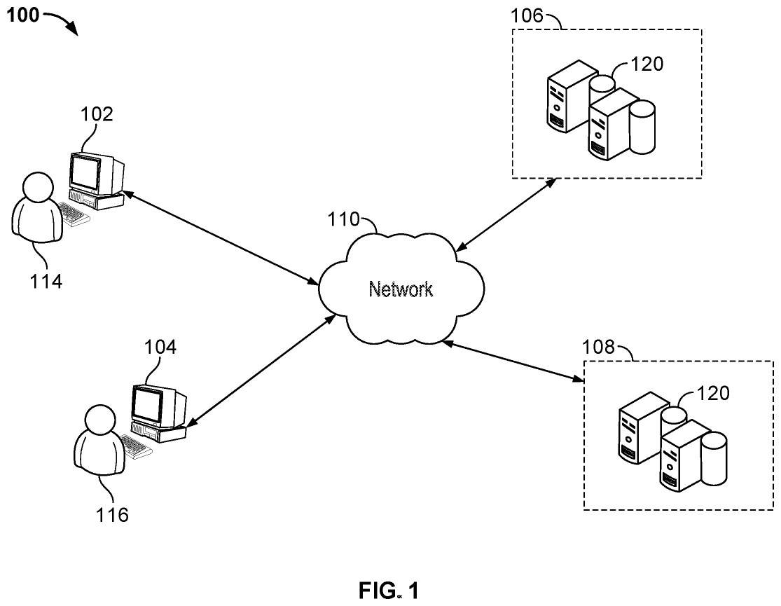

FIG. 1 depicts an environment architecture of an example computer-implemented system 100 that can execute implementations of the present disclosure. In the depicted example, the example system 100 includes a client device 102, a client device 104, a network 110, and a cloud environment 106 and a cloud environment 108. The cloud environment 106 may include one or more server devices and databases (e.g., processors, memory). In the depicted example, a user 114 interacts with the client device 102, and a user 116 interacts with the client device 104.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the cloud environment 106 include at least one server and at least one data store 120. In the example of FIG. 1, the cloud environment 106 is intended to represent various forms of servers including, but not limited to, a web server, an application server, a proxy server, a network server, and/or a server pool. In general, server systems accept requests for application services and provides such services to any number of client devices (e.g., the client device 102 over the network 110).

In accordance with implementations of the present disclosure, and as noted above, the cloud environment 106 can host applications and databases running on host infrastructure. In some instances, the cloud environment 106 can include multiple cluster nodes that can represent physical or virtual machines. A hosted application and/or service can run on VMs hosted on cloud infrastructure. In some instances, one application and/or service can run as multiple application instances on multiple corresponding VMs, where each instance is running on a corresponding VM.

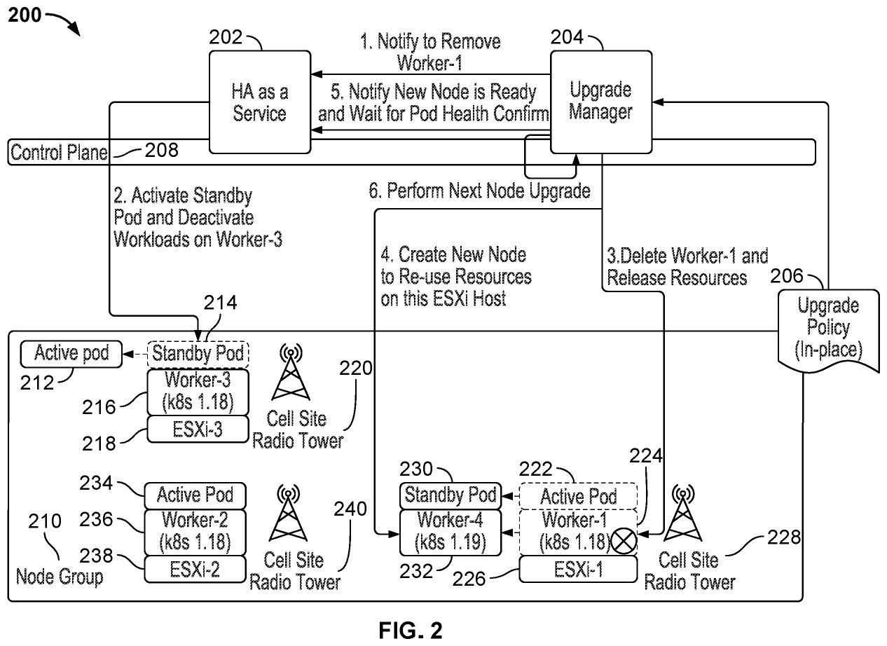

FIGS. 2 to 4 illustrate example systems for upgrade of nodes in a telco node cluster running CNFs, in accordance with example implementations of this disclosure. The aforementioned three upgrade strategies, namely, the in-place upgrade strategy, the node group upgrade strategy, and the rolling upgrade strategy, are illustrated in FIGS. 2 to 4 respectively. Every component shown and described in FIGS. 2 to 4 can be implemented as a computer system that executes computer instructions stored on a computer-readable medium.

FIG. 2 illustrates an example system 200 for upgrading, using in-place upgrade policy 206, nodes in node group 210 in a telco node cluster running RAN CNFs in a container orchestration platform and on cell sites, in accordance with an example implementation of this disclosure, where an upgrade manager 204 works with a HAaaS module 202 to upgrade worker-1 node 224, worker-2 node 236, and worker-3 node 216 in node group 210 in the container orchestration platform from an old version to a new version. The worker nodes 224, 236, and 216 are nodes that run containerized applications in the container orchestration platform. For example, the telco node cluster can be the Kubernetes™ Cluster in the container orchestration platform Kubernetes™, the old version can be k8s 1.18 for worker-1 node 224, worker-2 node 236, and worker-3 node 216, and the new version can be k8s 1.19 for worker-4 node 232. In some implementations, node group 210 includes multiple worker nodes in a cluster of worker nodes in the container orchestration platform. For example, the worker nodes in node group 210 can be worker-1 node 224, worker-2 node 236, and worker-3 node 216 shown in FIG. 2.

In some implementations, upgrade manager 204 can be a controller in the container orchestration platform, running as a pod in the telco node cluster. Upgrade manager 204 monitors node changes in the telco node cluster and sends messages about the monitored node changes to the HAaaS module 202. Upgrade manager 204 can apply different upgrade strategies on different types of node groups. Example types of node groups may include node group running 5G RAN CNFs and node group running 5G core CNFs.

In some implementations, HAaaS module 202 provides a service running inside or outside the telco node cluster. HAaaS module 202 sends CNF configuration to pods in node group 210, and activates/de-activates applications running in pods in node group 210 based on failure detection events. HAaaS module 202 also migrate network traffic from one worker node to another worker node to mitigate the service downtime.

In some implementations, worker nodes in node group 210 run RAN CNFs on cell sites. Each cell site radio tower is associated with one worker node in node group 210, e.g., cell site radio tower 228 is associated with worker-1 node 224, and only has one server for running one worker node in the container orchestration platform, e.g., cell site radio tower 228 only has one ESXi-1 server 226. The server of each cell site radio tower occupies all hardware resources available to that cell site radio tower. These hardware resources can include, but not limited to, field-programmable gate array (FPGA), as well as network interface controller (NIC) for single root input/output virtualization (SR-IOV).

In some implementations, a new node in node group 210 cannot be created first when upgrading a node in node group 210, because all hardware resources associated with the corresponding cell site radio tower are occupied by the node to be upgraded, and no additional hardware resources can be allocated to the new node to be created. Therefore an in-place upgrade policy, e.g., upgrade policy 206, needs to be implemented for upgrading nodes in node group 210 that are associated with corresponding cell site radio towers.

In some implementations, a customer resources definition (CRD) object for upgrade policy 206 needs to be created first and applied to nodes in node group 210, before these nodes are upgraded. An example code of the CRD object is shown below.

```
apiVersion: acm.vmware.com/v1alpha1
kind: UpgradePolicy
metadata:
  name: <policy-name>
spec:
  nodeGroup: nodeGroup-1
  upgradeStragety: in-place
  properties:
    replaceStrategy: oldFirst
  hooks:
  - stage: preNodeDelete
    action: notify
    params:
      url: http://<HAaas>/
  - stage: postNodeCreate
          action: notify
          params:
            url: http://<HAaaS>/
```

In some implementations, the example system 200 can execute the following steps to upgrade nodes in node group 210.

Step one: the upgrade manager 204 determines that one node in node group 210, e.g., worker-1 node 224, will be upgraded from old version k8s 1.18 to new version k8s 1.19. This upgrade process will be carried out according to upgrade policy (in-place) 206, by first removing from node group 210 worker-1 node 224 with old version k8s 1.18, then adding to node group 210 worker-4 node 232 with new version k8s 1.19. A web hook (http application programming interface (API) server) on node deletion process will be executed. Upgrade manager 204 then notifies HAaaS module 202, using a node deletion event, that worker-1 node 224 will be deleted.

Step two: HAaaS module 202 receives the node deletion event from upgrade manager 204 and activates, as active pod 212, standby pod 214 in worker-3 node 216. HAaaS module 202 migrates network traffic from active pod 222 in worker-1 node 224 to active pod 212 in worker-3 node 216, in order to reduce downtime associated with the upgrade process. HAaaS module 202 deactivates active pod 222 in worker-1 node 224.

Step three: upgrade manager 204 deletes worker-1 node 224 and releases all hardware resources previously occupied by worker-1 node 224. These hardware resources can include, but not limited to, FPGA, as well as NIC for SR-IOV.

Step four: upgrade manager 204 creates a new worker-4 node 232 with the new version k8s 1.19, on the same server where worker-1 node 224 was on, e.g., ESXi-1 server 226, with the same customization and hardware resource requirements used for worker-1 node 224. When worker-4 node 232 is ready, standby pod 230 will be automatically created on worker-4 node 232.

Step five: upgrade manager 204 notifies HAaaS module 202 that a new worker-4 node 232 has been created, and another hook will be executed when the new worker-4 node 232 is ready.

Step six: Repeat steps one through five for each remaining node in node group 210, until all the nodes in node group 210 are upgraded from the old version to the new version.

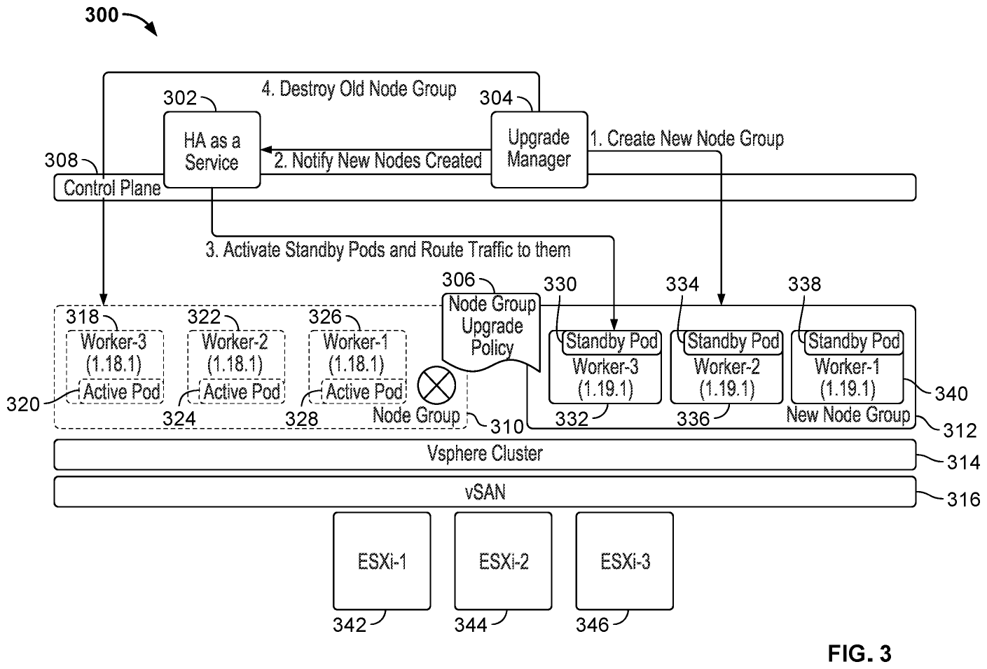

FIG. 3 illustrates an example system 300 for upgrading, using a node group upgrade policy 306, nodes in a node group 310 in a telco node cluster running 5G Core CNFs in a container orchestration platform, in accordance with another example implementation of this disclosure, where the nodes in the node group 310 run in a cluster 314 of hypervisor hosts with shared storage.

In some implementations, a customer resources definition (CRD) object for the node group upgrade policy 306 needs to be created first and applied to nodes in to-be-upgraded node group 310, before nodes in node group 310 are upgraded. An example code of the CRD object is shown below.

```
apiVersion: acm.vmware.com/v1alpha1
kind: UpgradePolicy
metadata:
  name: <policy-name>
spec:
  nodeGroup: nodeGroup-1
  upgradeStragety: in-place
  properties:
    newGroupName: nodeGroup-2
  hooks:
  - stage: preNodeDelete
    action: notify
    params:
      url: http://<HAaas>/
  - stage: postNodeCreate
          action: notify
          params:
  url: http://<HAaaS>/
```

In some implementations, the example system 300 can execute the following steps to upgrade nodes 318, 322, and 326 in node group 310 to nodes 332, 336, and 340 in new node group 312, respectively.

Step one: upgrade manager 304 creates new node group 312 with new nodes 332, 336, and 340 on new version of the container orchestration platform. The new nodes 332, 336, and 340 in new node group 312 are created with standby pods 330, 334, and 338, respectively.

Step two: upgrade manager 304 notifies HAaaS module 302 that new node group 312 with new nodes are created, and instructs HAaaS module 302 to migrate network traffic from nodes in old node group 310 to nodes in new node group 312.

Step three: HAaaS module 302 activates standby pods 330, 334, and 338 in new node group 312, and migrate network traffic from active pods 320, 324, and 328 in old node group 310 to activated nodes 330, 334, and 338 in new node group 312, respectively.

Step four: upgrade manager 304 deletes old node group 310 and all old nodes 318, 322, and 326 in it.

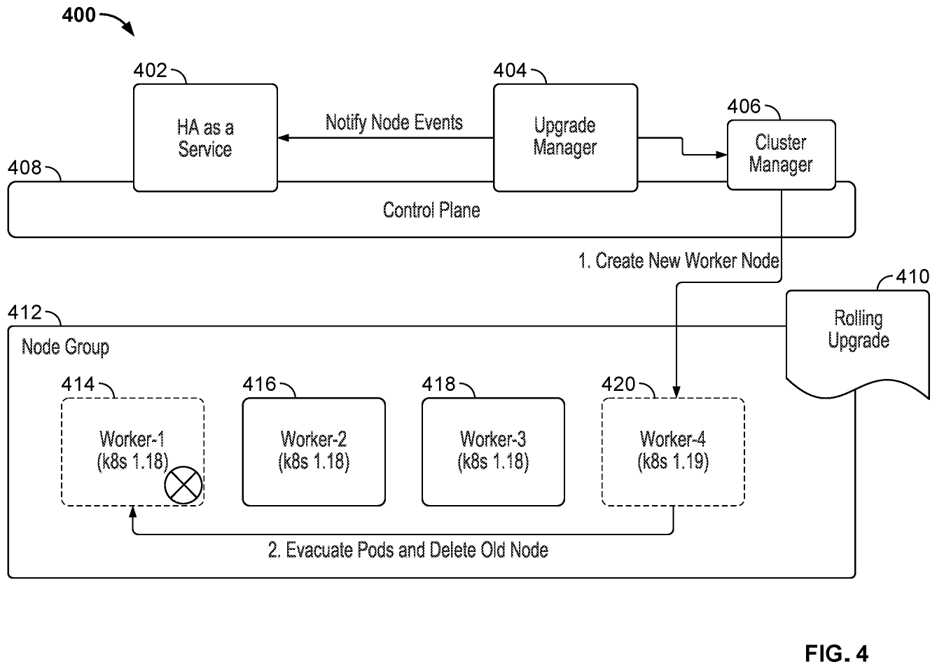

FIG. 4 illustrates an example system 400 for upgrading, using rolling upgrade policy 410, nodes in node group 412 in a telco node cluster running CNFs in a container orchestration platform, in accordance with a further example implementation of this disclosure, where a cluster manager 406 exists in the container orchestration platform.

In some implementations, upgrade manager 404 leverages cluster manager 406 to upgrade nodes 414, 416, and 418 in node group 412 under the rolling upgrade policy 410, where nodes 414, 416, and 418 are upgraded one by one after nodes in control panel 408 are upgraded by cluster manager 406. Upgrade manager 404 watches for node events and notifies HAaaS module 402 for migrating network traffic from an old node to a newly created node, in order to reduce service downtime associated with the upgrade process. In one example of upgrading node 414 that has an old version k8s 1.18, a new worker node 420 with a new version k8s 1.19 is first created in node group 412. The pod in node 414 is then destroyed. Pod in node 420 is created next. Finally node 414 is deleted from node group 412 to complete the process of upgrading node 414. During the aforementioned process of upgrading node 414, upgrade manager 404 watches for node events in node group 412 and notifies HAaaS module 402 for migrating network traffic from node 414 to node 420, in order to reduce service downtime associated with the process of upgrading node 414.

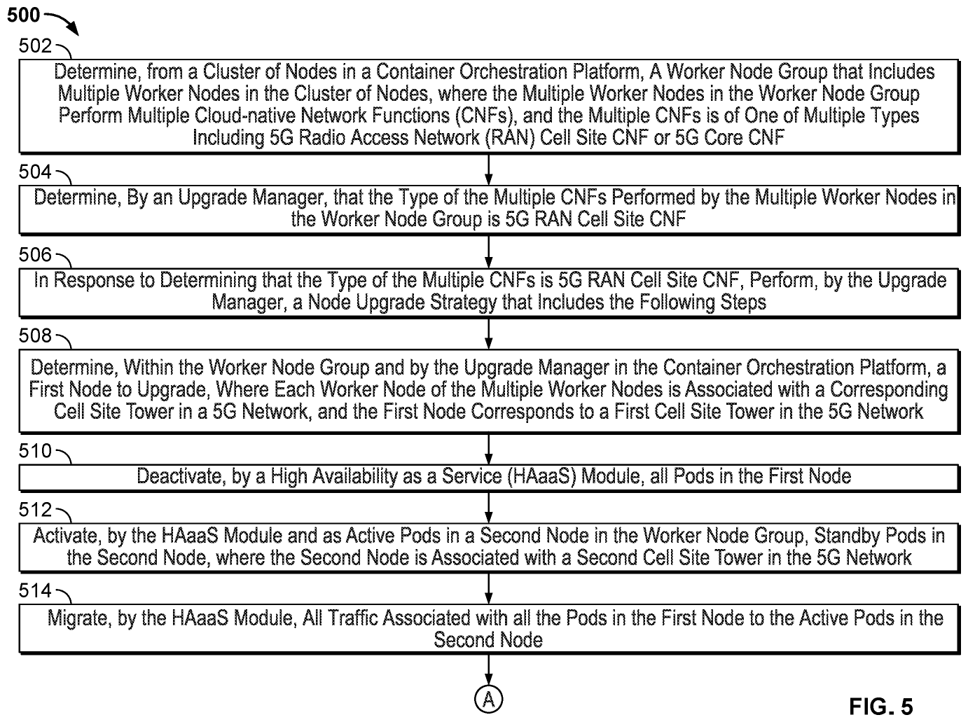

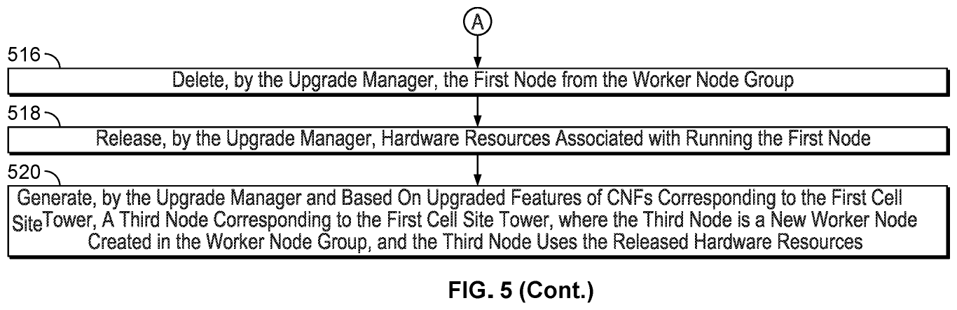

FIG. 5 illustrates an example case of cell site upgrade in telco node cluster running containerized applications, in accordance with example implementations of this disclosure.

At 502, a computer system determines, from a cluster of nodes in a container orchestration platform, a worker node group that includes multiple worker nodes in the cluster of nodes, where the multiple worker nodes in the worker node group perform multiple cloud-native network functions (CNFs), and the multiple CNFs is of one of multiple types including 5G radio access network (RAN) cell site CNF or 5G core CNF.

At 504, the computer system determines, by an upgrade manager, that the type of the multiple CNFs performed by the multiple worker nodes in the worker node group is 5G RAN cell site CNF.

At 506, in response to determining that the type of the multiple CNFs is 5G RAN cell site CNF, the computer system performs, by the upgrade manager, a node upgrade strategy that includes the following steps.

At 508, the computer system determines, within the worker node group and using an upgrade manager in the container orchestration platform, a first node to upgrade, where each worker node of the multiple worker nodes is associated with a corresponding cell site tower in a 5G network, and the first node corresponds to a first cell site tower in the 5G network.

At 510, the computer system deactivates, using a high availability as a service (HAaaS) module, all pods in the first node.

At 512, the computer system activates, using the HAaaS module and as active pods in a second node in the worker node group, standby pods in the second node, where the second node is associated with a second cell site tower in the 5G network.

At 514, the computer system migrates, using the HAaaS module, all network traffic associated with all the pods in the first node to the active pods in the second node.

At 516, the computer system deletes, using the upgrade manager, the first node from the worker node group.

At 518, the computer system releases, using the upgrade manager, hardware resources associated with running the first node.

At 520, the computer system generates, using the upgrade manager and based on upgraded features of CNFs corresponding to the first cell site tower, a third node corresponding to the first cell site tower, where the third node is a new worker node created in the worker node group, and wherein the third node uses the released hardware resources.

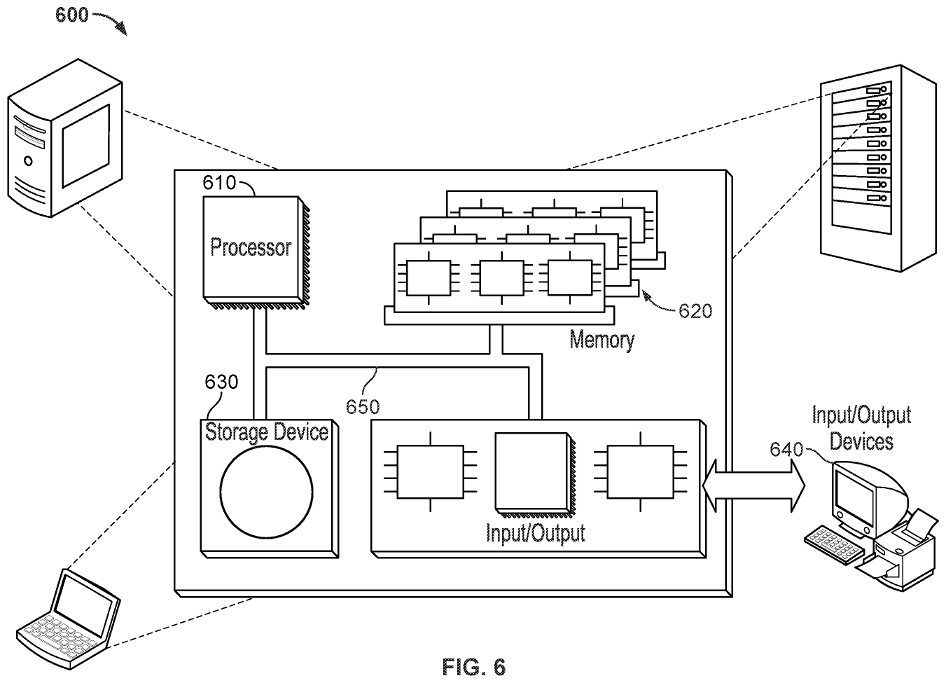

FIG. 6 illustrates a schematic diagram of an example computing system 600. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. The processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 is a volatile memory unit. The memory 620 is a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

Certain aspects of the subject matter described here can be implemented as a method. A worker node group that includes multiple worker nodes in the cluster of nodes is determined from a cluster of nodes in a container orchestration platform. The multiple worker nodes in the worker node group perform multiple cloud-native network functions (CNFs). The multiple CNFs is of one of multiple types including 5G radio access network (RAN) cell site CNF or 5G core CNF. The type of the multiple CNFs performed by the multiple worker nodes in the worker node group is determined to be 5G RAN cell site CNF. In response to determining that the type of the multiple CNFs is 5G RAN cell site CNF, a node upgrade strategy that includes the following steps is performed by the upgrade manager. A first node to upgrade is determined within the worker node group and by an upgrade manager in the container orchestration platform. Each worker node of the multiple worker nodes is associated with a corresponding cell site tower in a 5G network. The first node corresponds to a first cell site tower in the 5G network. All pods in the first node are deactivated by a high availability as a service (HAaaS) module. Standby pods in the second node are activated as active pods in a second node in the worker node group by the HAaaS module. The second node is associated with a second cell site tower in the 5G network. All network traffic associated with all the pods in the first node is migrated to the active pods in the second node by the HAaaS module. The first node is deleted from the worker node group by the upgrade manager. Hardware resources associated with running the first node are released by the upgrade manager. A third node corresponding to the first cell site tower is created by the upgrade manager and based on upgraded features of CNFs corresponding to the first cell site tower. The third node is a new worker node created in the worker node group, and wherein the third node uses the released hardware resources.

An aspect taken alone or combinable with any other aspect includes the following features. Before deactivating all the pods in the first node, a notification to notify the HAaaS module that the first node is to be deleted is sent to the HAaaS module by the upgrade manager.

An aspect taken alone or combinable with any other aspect includes the following features. After generating the third node corresponding to the first cell site tower, a notification to notify the HAaaS module that the third node is created is sent to the HAaaS module by the upgrade manager.

An aspect taken alone or combinable with any other aspect includes the following features. The hardware resources include at least one of a field programmable gate array (FPGA) or a single root input/output virtualization (SR-IOV) module.

An aspect taken alone or combinable with any other aspect includes the following features. The corresponding cell site tower in the 5G network includes one corresponding server with no shared storage. The corresponding server in each cell site tower in the 5G network occupies all hardware resources at the corresponding cell site tower for running the corresponding node in the worker node group.

An aspect taken alone or combinable with any other aspect includes the following features. The worker node group is a first worker node group. The multiple worker nodes is a first multiple worker nodes. The multiple CNFs is a first multiple CNFs. The upgrade strategy is a first upgrade strategy. A second worker node group that comprises a second multiple worker nodes in the cluster of nodes is determined from the cluster of nodes in the container orchestration platform. The second multiple worker nodes in the second worker node group perform a second multiple CNFs. It is determined by the upgrade manager that the type of the second multiple CNFs performed by the second multiple worker nodes in the second worker node group is 5G core CNF. In response to determining that the type of the second multiple CNFs is 5G core CNF, a second node upgrade strategy that is different from the first node upgrade strategy is performed by the upgrade manager.

An aspect taken alone or combinable with any other aspect includes the following features. The customization and hardware resource requirements for the third node are the same as customization and hardware resource requirements for the first node.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method, comprising:
determining, from a cluster of nodes in a container orchestration platform, a worker node group that comprises a plurality of worker nodes in the cluster of nodes, wherein the plurality of worker nodes in the worker node group perform a plurality of cloud-native network functions (CNFs), and wherein the plurality of CNFs is of one of a plurality of types comprising 5G radio access network (RAN) cell site CNF or 5G core CNF;
determining, by an upgrade manager, that the type of the plurality of CNFs performed by the plurality of worker nodes in the worker node group is 5G RAN cell site CNF; and
in response to determining that the type of the plurality of CNFs is 5G RAN cell site CNF, performing, by the upgrade manager, a node upgrade strategy, comprising:
determining, within the worker node group and by the upgrade manager in the container orchestration platform, a first node to upgrade, wherein each worker node of the plurality of worker nodes is associated with a corresponding cell site tower in a 5G network, and wherein the first node corresponds to a first cell site tower in the 5G network;
deactivating, by a high availability as a service (HAaaS) module, all pods in the first node;
activating, by the HAaaS module and as active pods in a second node in the worker node group, standby pods in the second node, wherein the second node is associated with a second cell site tower in the 5G network;
migrating, by the HAaaS module, all network traffic associated with all the pods in the first node to the active pods in the second node;
deleting, by the upgrade manager, the first node from the worker node group;
releasing, by the upgrade manager, hardware resources associated with running the first node; and
generating, by the upgrade manager and based on upgraded features of CNFs corresponding to the first cell site tower, a third node corresponding to the first cell site tower, wherein the third node is a new worker node created in the worker node group, and wherein the third node uses the released hardware resources.

2. The computer-implemented method according to claim 1, wherein before deactivating all the pods in the first node, the method further comprises:
sending, by the upgrade manager and to the HAaaS module, a notification to notify the HAaaS module that the first node is to be deleted.

3. The computer-implemented method according to claim 1, wherein after generating the third node corresponding to the first cell site tower, the method further comprises:
sending, by the upgrade manager and to the HAaaS module, a notification to notify the HAaaS module that the third node is created.

4. The computer-implemented method according to claim 1, wherein the hardware resources comprise at least one of a field programmable gate array (FPGA) or a single root input/output virtualization (SR-IOV) module.

5. The computer-implemented method according to claim 1, wherein the corresponding cell site tower in the 5G network comprises one corresponding server with no shared storage, and wherein the corresponding server occupies all hardware resources at the corresponding cell site tower for running the corresponding node in the worker node group.

6. The computer-implemented method according to claim 1, wherein the worker node group is a first worker node group, wherein the plurality of worker nodes is a first plurality of worker nodes, wherein the plurality of CNFs is a first plurality of CNFs, wherein the upgrade strategy is a first upgrade strategy, and wherein the method further comprises:
determining, from the cluster of nodes in the container orchestration platform, a second worker node group that comprises a second plurality of worker nodes in the cluster of nodes, wherein the second plurality of worker nodes in the second worker node group perform a second plurality of CNFs;
determining, by the upgrade manager, that the type of the second plurality of CNFs performed by the second plurality of worker nodes in the second worker node group is 5G core CNF; and
in response to determining that the type of the second plurality of CNFs is 5G core CNF, performing, by the upgrade manager, a second node upgrade strategy that is different from the first node upgrade strategy.

7. The computer-implemented method according to claim 1, wherein customization and hardware resource requirements for the third node are the same as customization and hardware resource requirements for the first node.

8. A non-transitory, computer-readable medium storing one or more instructions executable by a computer system to perform operations, the operations comprising:
determining, from a cluster of nodes in a container orchestration platform, a worker node group that comprises a plurality of worker nodes in the cluster of nodes, wherein the plurality of worker nodes in the worker node group perform a plurality of cloud-native network functions (CNFs), and wherein the plurality of CNFs is of one of a plurality of types comprising 5G radio access network (RAN) cell site CNF or 5G core CNF;
determining, by an upgrade manager, that the type of the plurality of CNFs performed by the plurality of worker nodes in the worker node group is 5G RAN cell site CNF; and
in response to determining that the type of the plurality of CNFs is 5G RAN cell site CNF, performing, by the upgrade manager, a node upgrade strategy, comprising:
determining, within the worker node group and by the upgrade manager in the container orchestration platform, a first node to upgrade, wherein each worker node of the plurality of worker nodes is associated with a corresponding cell site tower in a 5G network, and wherein the first node corresponds to a first cell site tower in the 5G network;
deactivating, by a high availability as a service (HAaaS) module, all pods in the first node;
activating, by the HAaaS module and as active pods in a second node in the worker node group, standby pods in the second node, wherein the second node is associated with a second cell site tower in the 5G network;
migrating, by the HAaaS module, all network traffic associated with all the pods in the first node to the active pods in the second node;
deleting, by the upgrade manager, the first node from the worker node group;
releasing, by the upgrade manager, hardware resources associated with running the first node; and
generating, by the upgrade manager and based on upgraded features of CNFs corresponding to the first cell site tower, a third node corresponding to the first cell site tower, wherein the third node is a new worker node created in the worker node group, and wherein the third node uses the released hardware resources.

9. The non-transitory, computer-readable medium according to claim 8, wherein before deactivating all the pods in the first node, the operations further comprise:
sending, by the upgrade manager and to the HAaaS module, a notification to notify the HAaaS module that the first node is to be deleted.

10. The non-transitory, computer-readable medium according to claim 8, wherein after generating the third node corresponding to the first cell site tower, the operations further comprise:
sending, by the upgrade manager and to the HAaaS module, a notification to notify the HAaaS module that the third node is created.

11. The non-transitory, computer-readable medium according to claim 8, wherein the hardware resources comprise at least one of a field programmable gate array (FPGA) or a single root input/output virtualization (SR-IOV) module.

12. The non-transitory, computer-readable medium according to claim 8, wherein the corresponding cell site tower in the 5G network comprises one corresponding server with no shared storage.

13. The non-transitory, computer-readable medium according to claim 12, wherein the corresponding server occupies all hardware resources at the corresponding cell site tower for running the corresponding node in the worker node group.

14. The non-transitory, computer-readable medium according to claim 8, wherein customization and hardware resource requirements for the third node are the same as customization and hardware resource requirements for the first node.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, the one or more operations comprising:
determining, from a cluster of nodes in a container orchestration platform, a worker node group that comprises a plurality of worker nodes in the cluster of nodes, wherein the plurality of worker nodes in the worker node group perform a plurality of cloud-native network functions (CNFs), and wherein the plurality of CNFs is of one of a plurality of types comprising 5G radio access network (RAN) cell site CNF or 5G core CNF;
determining, by an upgrade manager, that the type of the plurality of CNFs performed by the plurality of worker nodes in the worker node group is 5G RAN cell site CNF; and
in response to determining that the type of the plurality of CNFs is 5G RAN cell site CNF, performing, by the upgrade manager, a node upgrade strategy, comprising:
determining, within the worker node group and by the upgrade manager in the container orchestration platform, a first node to upgrade, wherein each worker node of the plurality of worker nodes is associated with a corresponding cell site tower in a 5G network, and wherein the first node corresponds to a first cell site tower in the 5G network;
deactivating, by a high availability as a service (HAaaS) module, all pods in the first node;
activating, by the HAaaS module and as active pods in a second node in the worker node group, standby pods in the second node, wherein the second node is associated with a second cell site tower in the 5G network;
migrating, by the HAaaS module, all network traffic associated with all the pods in the first node to the active pods in the second node;
deleting, by the upgrade manager, the first node from the worker node group;
releasing, by the upgrade manager, hardware resources associated with running the first node; and
generating, by the upgrade manager and based on upgraded features of CNFs corresponding to the first cell site tower, a third node corresponding to the first cell site tower, wherein the third node is a new worker node created in the worker node group, and wherein the third node uses the released hardware resources.

16. The computer-implemented system according to claim 15, wherein before deactivating all the pods in the first node, the one or more operations further comprise:
sending, by the upgrade manager and to the HAaaS module, a notification to notify the HAaaS module that the first node is to be deleted.

17. The computer-implemented system according to claim 15, wherein after generating the third node corresponding to the first cell site tower, the one or more operations further comprise:
sending, by the upgrade manager and to the HAaaS module, a notification to notify the HAaaS module that the third node is created.

18. The computer-implemented system according to claim 15, wherein the hardware resources comprise at least one of a field programmable gate array (FPGA) or a single root input/output virtualization (SR-IOV) module.

19. The computer-implemented system according to claim 15, wherein the corresponding cell site tower in the 5G network comprises one corresponding server with no shared storage.

20. The computer-implemented system according to claim 19, wherein the corresponding server occupies all hardware resources at the corresponding cell site tower for running the corresponding node in the worker node group.
